(19) United States
(12) Patent Application Publication
(10) Pub. No.: US 2013/0227014 A1
(43) Pub. Date: Aug. 29, 2013

(54) DATA SHARING SYSTEM AND METHOD

(71) Applicant: PANTECH CO., LTD., (US)

(72) Inventor: Won Min SONG, Seoul (KR)

(73) Assignee: PANTECH CO., LTD., Seoul (KR)

(21) Appl. No.: 13/737,554

(22) Filed: Jan. 9, 2013

(30) Foreign Application Priority Data
Feb. 29, 2012 (KR) 10-2012-0021460

(51) Int. Cl. H04L 29/08

(52) U.S. Cl. CPC H04L 67/10
USPC 709/204

(57) ABSTRACT

A method for sharing data between multiple devices includes transmitting a request for sharing data, receiving a layout file corresponding to the shared data, extracting at least one of a layout configuration and an object included in the layout file, receiving resources corresponding to at least one of the layout configuration and the object, applying the received resources to at least one of the layout configuration and the object, and configuring a user interface using the applied layout configuration and the object. A data sharing device includes a layout file analyzer to receive a layout file and to extract a layout configuration and an object, a resource processor to receive resources corresponding to at least one of the layout configuration and the object, and an output unit to apply the resources to at least one of the layout configuration and the object.

### CROSS-REFERENCE TO RELATED APPLICATION

This application claims priority from and the benefit of Korean Patent Application No. 10-2012-0021460, filed on Feb. 29, 2012, which is hereby incorporated by reference for all purposes as if fully set forth herein.

### BACKGROUND

1. Field

The present disclosure relates to a data sharing system and method, more particularly, to a data sharing system and method to share data between devices operating in different operating system (OS) environments.

2. Discussion of the Background

Recently, users increasingly own and make use of various devices, such as a smart phone, a personal computer (PC), a smart television (TV), a vehicle navigation device, a tablet personal computer (PC), and the like.

As described above, as users own and make use of a plurality of devices, a sharing issue between devices occurs. Sharing between devices includes data sharing and execution environment sharing.

An example of a data sharing method includes sharing data by using a web-based cloud environment.

FIG. 1 illustrates data sharing between devices of a related art having the same operating system (OS) environments using a cloud network.

Here, share data Data 1 is shared between two devices, both of which are equipped with Android® OS. Similarly, share data Data 2 is shared between two devices having Windows® OS.

Here, although devices having different OS environments (e.g., Android® and Windows®) may share data, the devices of differing OS environment may not be able to use the shared data. More specifically, while a first device equipped with an Android® OS environment may transmit share data to a second device equipped with a Windows® OS environment, the second device may be unable to use the received share data.

More specifically, while a first device operating in a Windows® environment may transmit a share data to a second device operating in an Android® environment, the second device may be unable to use the received share data. Accordingly, although the first device and the second device may be able to transmit and receive the share data, if an application used to process the shared data is executed in the Windows® environment but is not executed in the Android® environment, the second device may not be able to use the received share data.

Various methods to share data have been proposed, for example, using one of a remote control method, a method of developing corresponding applications for each OS, a method of executing an application in a cloud environment, and the like.

FIG. 2 illustrates a remote control method, in which a second device 2 remotely controls a first device 1 to share data between devices operating in different OS environments.

First, the second device 2 connects to the first device 1 and requests to transmit a screen. The first device 1 captures an image displayed on its screen and transmits the image to the second device 2. The second device 2 outputs the image received from the first device 1. When user input is detected on the image displayed on the second device 2, coordinates corresponding to user input are transmitted to the first device 1. The first device 1 converts the coordinates received from the second device 2 into coordinates corresponding to the first device 1, processes the converted coordinates, applies the result of processed coordinates to the image, captures the image with the applied results, and transmits the captured image to the second device 2.

However, since the remote control method repeatedly captures and transmits the screen according to a change in the shared image, which may be caused by a user input, increased load is applied to network traffic to decrease information processing rate.

In addition, as sizes of mobile device screens have increased, the size of captured images have increased as well, thereby causing an increase in the traffic load.

In addition, if the first device 1 and the second device 2 have different screen sizes, the first device 1 needs to convert the coordinates received from the second device 2 into the coordinates of the first device 1, for appropriate processing. Such coordinate conversion may additionally burden real-time operations and may cause errors due to additional burdens attributed to converting differences in the aspect ratio and an input position. Such errors may contribute to malfunction of the respective devices.

In addition, if the first device 1 and the second device 2 have different screen sizes, in which the second device 2 having a smaller screen is remotely connected to the first device 1 having a larger screen, an image may not be shared properly and may require additional processing even to be transmitted. More specifically, since the second device 2 displays an image larger than the screen provided thereon, the image is cut or scrolling operation may need to be performed on the screen to view the image. If the screen is reduced, an image displayed thereon may become distorted and a user may not recognize the image.

FIG. 3 illustrates a method for separately developing the application for each OS. Here, an application operating in each OS environment is independently developed. For example, application X may be developed and configured specifically to operate in an Android® OS environment, and application X may be separately developed and configured specifically to operate in a Windows® OS environment.

However, if applications operating in each OS environment are independently developed, a developer needs to develop an application for each OS, such as a Windows® application, an Android® application, an iOS® application, and the like. Thus, burdens imposed on application development are increased and some developers may limit their products to certain OS environments.

FIG. 4 illustrates providing of an application in a cloud environment. The cloud environment provides a web application, which is executed in a server and not in the device itself.

Web browsers are created differently in accordance with specifications of the OS environments. However, content displayed using a web browser includes a hypertext markup language (HTML), a personal hypertext preprocessor (PHP) and a Java server page (JSP), and the like, which may be unified as a whole regardless of the OS environment in a respective device.

In consideration of this, a device may access a cloud environment, which provides a web application that is executed in a server connected to a network.

Since the web application is executed in the server and the device receives and outputs a result through the web application executed in the server, the device and the server may operate in different OS environments.

However, the web applications found in cloud environments are not diversified and may be limited in type. Further, data format may differ between different providers of the web applications and may not be commonly used.

### SUMMARY

Exemplary embodiments of the present invention provide a method for sharing data between a first device and a second device.

Exemplary embodiments of the present invention also provide a data sharing system including a first device and a second device.

Additional features of the invention will be set forth in the following description, and in part will be apparent from the description, or may be learned from practice of the invention.

An exemplary embodiment of the present invention discloses a method for sharing data between a first device and a second device. The method includes: transmitting, by the first device, a request for sharing data to the second device; receiving, at the first device, a layout file corresponding to the shared data of the second device; extracting, at the first device, at least one of a layout configuration and an object included in the layout file; receiving, at the first device, resources corresponding to at least one of the layout configuration and the object from an external source; applying, at the first device, the received resources to at least one of the layout configuration and the object; and configuring, at the first device, a user interface using the applied layout configuration and the object.

An exemplary embodiment of the present invention also discloses a data sharing system including a first device and a second device. The first device includes: a layout file analyzer to receive a layout file and to extract a layout configuration and an object included in the layout file, the layout file corresponding to shared data of the second device; a resource processor to receive resources corresponding to at least one of the layout configuration and the object from an external source; and an output unit to apply the resources to at least one of the layout configuration and the object and to configure a user interface using the applied layout configuration and the object.

An exemplary embodiment of the present invention also discloses a method for sharing an application between a first device and a second device. The method includes: transmitting, by the first device, a request for sharing the application to the second device; receiving, at the first device, a layout file of the application being executed in the second device; extracting, at the first device, a layout configuration, an object, and corresponding resource identification (ID) included in the layout file; receiving, at the first device, resources corresponding to the layout configuration and the object from an external source using the resource ID; applying, at the first device, the received resources to the layout configuration and the object; and configuring a user interface using the applied layout configuration and the object.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 illustrates data sharing between devices of a related art having the same operating system (OS) environments using a cloud network.

FIG. 2 illustrates a remote control method, in which a second device remotely controls a first device in order to share data between devices operating in different OS environments.

FIG. 3 illustrates a method for separately developing the application for each OS.

FIG. 4 illustrates providing of an application in a cloud environment.

FIG. 5 is a schematic diagram illustrating a configuration of a transmission device according to an exemplary embodiment of the present invention.

FIG. 6 is a schematic diagram illustrating a configuration of a reception device according to an exemplary embodiment of the present invention.

FIG. 7 is a flow diagram illustrating an operation sequence between a reception device and a transmission device according to an exemplary embodiment of the present invention.

FIG. 8 is a flow diagram illustrating an operation sequence between a reception device and a cloud server according to an exemplary embodiment of the present invention.

FIG. 9 is a flowchart illustrating a data sharing method according to an exemplary embodiment of the present invention.

FIG. 10 is a flowchart illustrating a data sharing method according to an exemplary embodiment of the present invention.

FIG. 11, FIG. 12, FIG. 13, FIG. 14 and FIG. 15 are diagrams illustrating an operation of a data sharing system according to exemplary embodiments of the present invention.

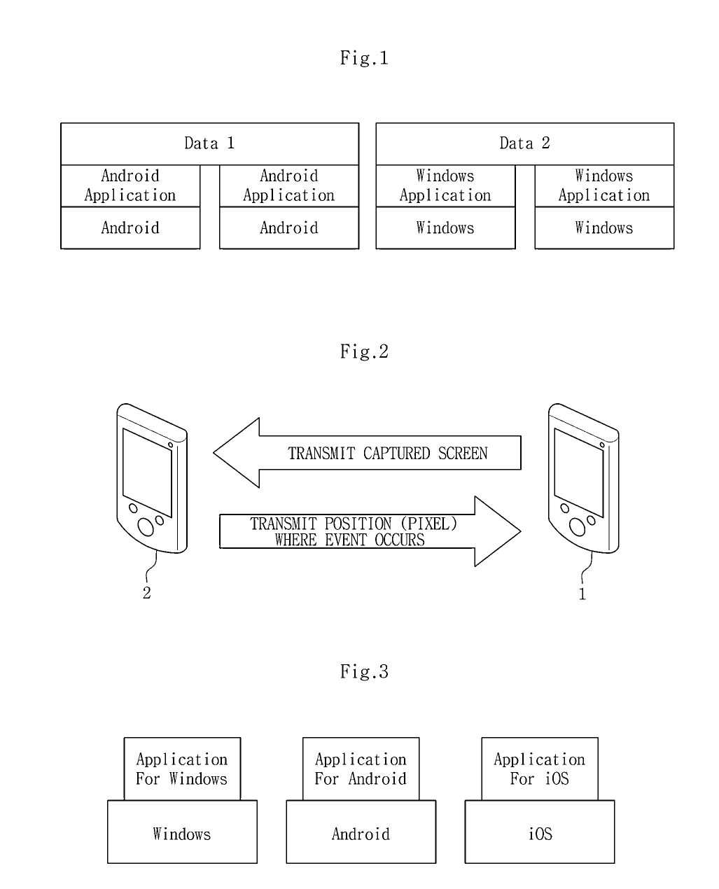

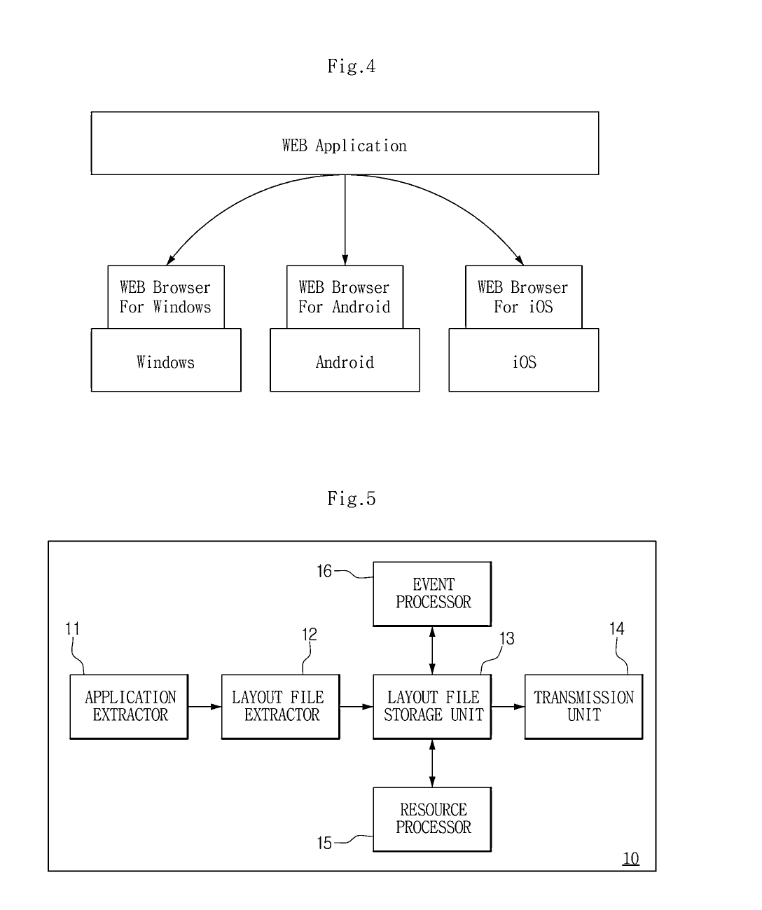

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

One or more applications may follow an implementation scheme according to a model-view-controller (MVC) pattern.

The MVC pattern may refer to a pattern used to divide an application into multiple regions, which may include, without limitation, a model region, a view region, and a controller region to reduce a coupling degree between the regions.

The model region may refer to information or data of an application. The view region may refer to a user interface element, such as a text, a checkbox, or the like. The controller region may manage interaction between data and business logic.

If the application is developed according to the MVC pattern, the business logic may be separated from the user interface to create an application, which may be able to correct a visual element of the application or the business logic executed without influencing each other. The business logic may be executed without generating visual elements.

As described above, the application developed according to the MVC pattern may configure a user interface as one independent module. However, the aspects of the invention are not limited thereto, such that the invention can be implemented according to various schemes and patterns different from the MVC patterns. A user interface may be configured using an eXtensible Markup Language (XML) when an Android® operating system (OS) is used. A user interface may be configured using an eXtensible Application Markup Language (XAML) when a Windows® OS is used. A user interface may be configured using a Xiamen International Bank (XIB) when an iOS® OS is used. However, aspects of the present invention are not limited thereto, such that other software, programming languages, and OSs may be used.

The XML, XMAL and XIB may be different from one another in the expression format, but they may all belong to the XML family. Accordingly, user interfaces of one or more OS environments may be expressed using the XML. However, aspects of the invention are not limited thereto, such that different programming may be used. Further, different OS may use different family of languages.

Layout information used to express or display a user interface of an application may be shared, such that a plurality of devices operating in different OS environments may share the same or similar user interface of the application, which may allow sharing of data.

As described above, a layout file used to share a user interface of an application between devices operating in different OS environments may be implemented by an XML file. The layout file may include, without limitation, at least one of a data, a unique value identification (ID), padding, size, position information, and the like, as shown in Table 1.

The data included in the layout file may refer to attributes of data. Further, the data included in the layout file may indicate a method of representing the data and the ID of the data included in the layout file.

The unique value identification (ID) may indicate a unique ID value of the layout file.

The padding of the layout file may indicate values representing a top, a bottom, a left and a right padding.

The size of the layout file may indicate the height and width of the layout.

The position of the layout file may indicate the position of a screen or image layout displayed on a screen. In an example, information that may be included in a layout file, including type information, XML property information, and description information, may be provided in Table 1 illustrated below.

TABLE 1

| Type | XML Properties | Description |
|---|---|---|
| Data | Background | source |
| | Src | |
| | Scale Type | |
| ID | Id | unique value |
| Padding | Padding Bottom | padding |
| | Padding Left | |
| | Padding Right | |
| | Padding Top | |
| Size | Layout_height | size |
| | Layout_width | |
| Position | Layout_above | position |
| | Layout_below | |
| | Layout_toLeftOf | |
| | Layout_toRightOf | |
| | Layout_alignParentBottom | |
| | Layout_alignParentLeft | |
| | Layout_alignParentRight | |
| | Layout_alignParent | |

Table 1 lists attributes of the layout file according to exemplary embodiments of the present invention. However, aspects of the invention are not limited thereto and additional or fewer attributes may be considered.

Although the present disclosure is provided with respect to the Android® OS, the Windows® OS, and the iOS® OS, other OS environments may be applicable. For purposes of disclosure, exemplary embodiments of the present invention will be described with respect to a device operating in the Android® environment sharing data with the device operating in the Windows® OS or the iOS® OS environment. However, aspects of the invention are not limited thereto, such that a device operation in the Windows® OS or the iOS® OS may share data with the device operating in the Android® environment.

FIG. 5 is a schematic diagram illustrating a configuration of a transmission device according to an exemplary embodiment of the present invention.

As shown in FIG. 5, the transmission device 10 includes an application extractor 11, a layout file extractor 12, a layout file storage unit 13, a transmission unit 14, a resource processor 15, and an event processor 16.

The application extractor 11 may extract an application to be shared with at least one reception device 20 operating in a heterogeneous OS environment. However, aspects of the invention are not limited thereto, such that the application extractor 11 may be a general extractor to extract data, image, video, or information to be shared.

The application extractor 11 may acquire a package name, which may be a unique ID value of the application to be shared, search to identify an application having the package name in a system/application region or a data/application region of an internal memory (e.g., flash memory), and extract the application.

The layout file extractor 12 may extract a layout file of the application extracted by the application extractor 11.

More specifically, the layout file extractor 12 may acquire a resource ID of an execution screen or a displayed image of the application extracted by the application extractor 11, acquire a layout file name matching the resource ID of the execution screen, and extract the layout file using the acquired layout file name.

The layout file storage unit 13 may store the layout file extracted by the layout file extractor 12.

The transmission unit 14 may transmits information associated with the transmission device 10 and the extracted layout file to a reception device 20 via a network, including, without limitation, a short range wireless communication network (e.g., Zigbee®, Bluetooth®, Wi-Fi®, and the like), a wired Internet network, a wireless Internet network (e.g., a wideband code division multiple access (WCDMA) network, a fourth generation (4G) mobile communication network, a Long Term Evolution (LTE) network, an A11-IP (internet protocol) network, etc.).

The transmission device 10 and the reception device 20 may continuously communicate with each other while sharing data or an application or may communicate with each other when data is transmitted and/or received between devices.

Information related to the transmission device 10 transmitted to the reception device 20 through the transmission unit 14 may be used to establish communication between the reception device 20 and the transmission device 10, such as a telephone number, an IP address, and network information.

When a resource request is received from the reception device 20, the resource processor 15 may search for resources that may be used by the application, which may include, without limitation, an image, audio, video, a text string, a layout, an XML file, and the like, using a resource ID. The resource ID may be used in the resource request, for example, the resource ID is automatically applied to R.java. Further, the resource processor 15 may transmit one or more identified resources to the reception device 20 through the transmission unit 14.

When an event processing request is received from the reception device 20, the event processor 16 may determine whether the event is an end event based on at least one of an object ID, an event type, a layout ID, an application ID, and the like, which may be included in the event processing request. Further, the event processor 16 may perform an end or a termination process if the event is determined to be an end event. If the event is determined not to be an end event, a listener interface or operation (i.e., an interface or operation for processing a specific event) of the event, which may occur between a user and an application or between applications and corresponds to an operation to touch a screen or press a key by the user to utilize a program, may be executed. If the resources of an object are changed by executing the listener interface or operation, resources may be extracted from the layout file storage unit 13 and transmitted to the reception device 20 through the transmission unit 14. If the layout of the image is changed, the layout file may be extracted from the layout file storage unit 13 and transmitted to the reception device 20 through the transmission unit 14.

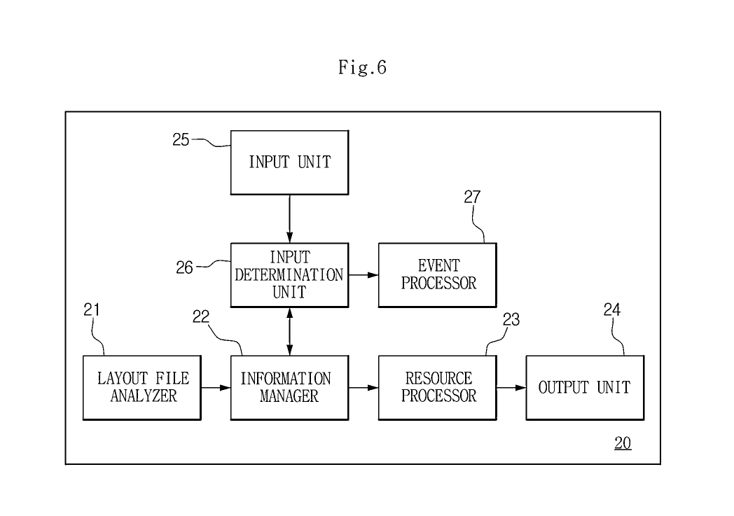

FIG. 6 is a schematic diagram illustrating a configuration of a reception device according to an exemplary embodiment of the present invention.

As shown in FIG. 6, the reception device 20 includes a layout file analyzer 21, an information manager 22, a resource processor 23, an output unit 24, an input unit 25, an input determination unit 26, and an event processor 27.

The layout file analyzer 21 may analyze the layout file received from the transmission device 10, extract a layout configuration of an image displayed on a screen and an object information or layer included in the layout file (e.g. an object received from a user, an object for receiving input from an user, or an object for displaying data on the screen, such as a text view, an image view, or a button), represent the layout configuration and the object information or layer in a form of a tree, and configure an image layer using the layout configuration and the object information or layer represented in the form of the tree. However, aspects of the invention are not limited thereto, such that the objects are displayed in other forms.

The layout file analyzer 21 may analyze the layout file using a document object model (DOM) analyzer, which may be a type of an XML analyzer.

The information manager 22 may store information used to process the layout, which may include, without limitation, at least one of transmission device information, application information, layout information, object information, resource information, and the like.

The transmission device information may be information used to establish communication with the transmission device 10. Communication with the transmission device may be established to request additional information from the transmission device 10, such as a telephone number, an IP address, network information, and the like.

The transmission device information may be received when the layout file is received from the transmission device 10, before the layout file is received, or after the layout file is received.

The application information may refer to information associated with the application executed in the reception device 20 through sharing with the transmission device 10. Further, the reception device 20 may manage information associated with the application, in which layout configuration may be included therein. The layout configuration may be subordinate to the application or part of the application information.

Further, the application information may be used as a criterion to determine the application to which layout configuration is subordinate. More specifically, the application information may be used to determine a subordination relationship or a relationship of the layout configuration with one or more applications or data. For example, the application information may indicate that a layout file 1 has a subordination relationship or is a subordinate to an application 1.

The layout information may refer to information about the layout configuration, which may be subordinate to the execution screen of the application executed in the reception device 20 through a sharing operation with the transmission device 10. The layout information may include or manage information about which object is subordinate to a layout or a subordination relationship between one or more objects and a layout.

The layout information may be used as a criterion to determine to which layout configuration the object information or layer is a subordinate. More specifically, the layout information may be used to determine a subordination relationship or a corresponding relationship between an object and a layout. In an example, the object information or layer may be disposed on a base layer or a layout layer according to the layout configuration.

The object information may refer to information about the object information or layer, which may be subordinate to its corresponding layout configuration. The object information or layer may specify a range or parameters of the application when requesting the transmission device 10 to process an event occurring in the reception device 20 or when requesting resources from the transmission device 10 in order to apply the resources. The transmission device 10 may distinguish between object information or layers used to request event processing and object information or layer used to request resources according to the object information.

The resource information may refer to information about resources applied to one or more objects. Further, the resource information may be changed in real time according to a result of processing an event.

The resource processor 23 may extract a resource ID included in the layout configuration and the object information or layer extracted by the layout file analyzer 21. The resource processor 23 may transmit the extracted resource ID to the transmission device 10 or to a cloud server (not shown) to request resources, and may receive a processing result from the transmission device 10 or the cloud server.

The output unit 24 may apply the resources received through the resource processor 23 to the layout configuration and the object information or layer extracted by the layout file extractor 21 to configure a user interface. The output unit 24 may output the user interface on the screen. Further, the layout configuration and the object information or layer of the user interface may be updated according to the resources received from the resource processor.

The input unit 25 may detect a physical user input and may send a position and a type (e.g. touch, flicking, etc.) of the detected physical input to the input determination unit 26. However, the aspects of the invention are not limited thereto. For example, input may be also received from an internal device (e.g. a clock, a timer), an external device (e.g. a temperature sensor, stock market quotes received via an internet communication, a purchase request received via an internet connection), software/application installed on the reception device (e.g. an application receiving data from the transmission device and displaying the data as a plot or graph on the reception device), a device communicating with the reception device, or a combination thereof.

The input determination unit 26 may extract an ID of an object or object layer associated with an event occurrence, a type of the event, a layout ID, an application ID, and transmission device 10 information from the information manager 22 based on user input detected by the input unit 25.

The event processor 27 may establish communication with the transmission device 10 using the transmission device 10 information extracted by the input determination unit 26. The event processor 27 may transmit at least one of the object ID, the event type, the layout ID, and the application ID to the transmission device 10 to request event processing, and may receive a result of the requested event processing.

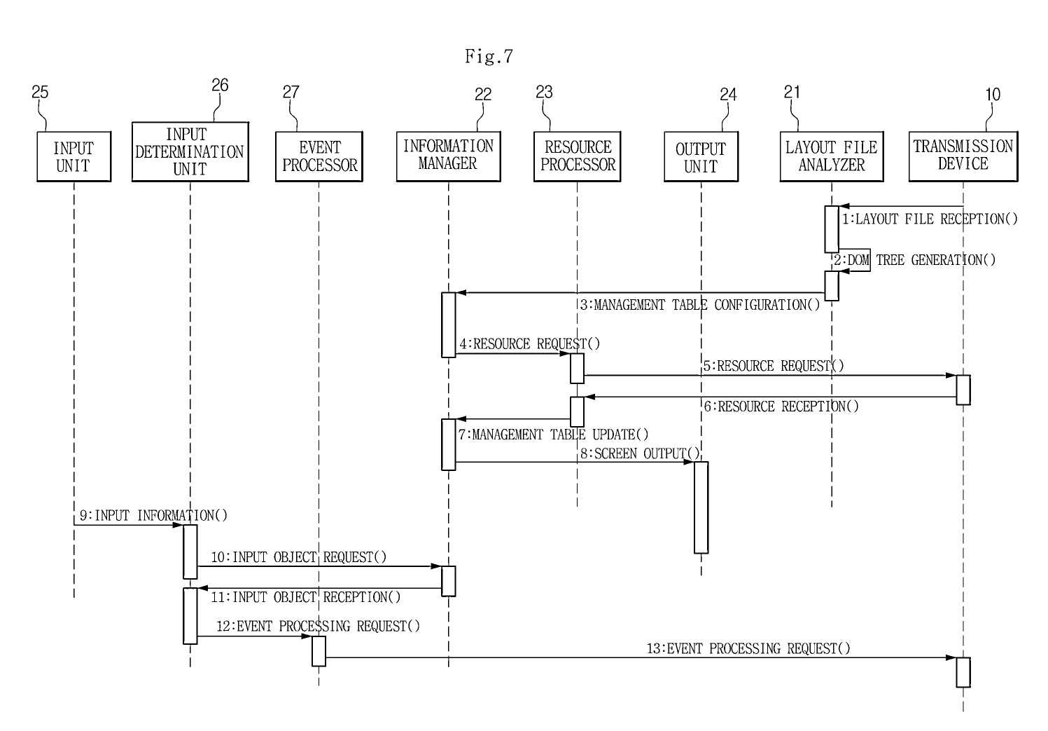

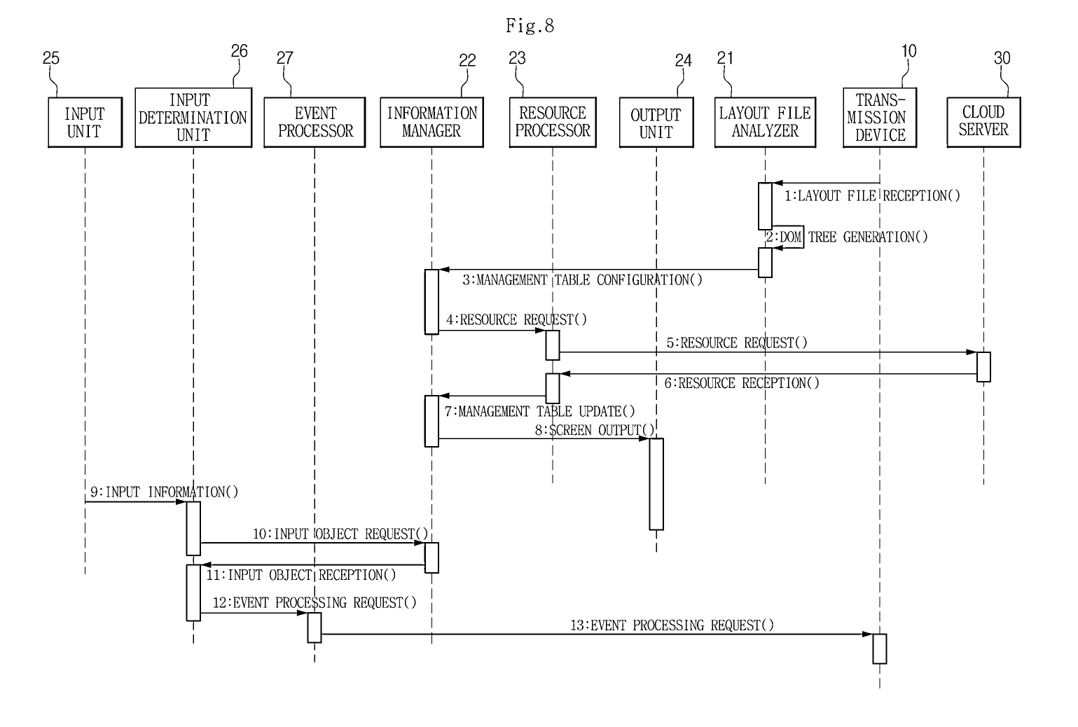

FIG. 7 is a flow diagram illustrating operation sequence between a reception device and a transmission device according to an exemplary embodiment of the present invention. FIG. 8 is a flow diagram illustrating an operation sequence between a reception device and a cloud server according to an exemplary embodiment of the present invention. Operations of FIG. 7 and FIG. 8 may be similar to one another with an exception of operation 5 and operation 6. Accordingly, operations described herein may refer to at least one of FIG. 7 and FIG. 8, unless otherwise specified. However, aspects of the invention are not limited thereto, such that same operations are performed in both FIG. 7 and FIG. 8.

In operation 1, the transmission device 10 transmits a layout file of the transmission device 10 to a layout file analyzer 21. In operation 2, when the layout file is received from the transmission device 10, the layout file analyzer 21 of the reception device 20 may analyze the layout file. For example, the layout file analyzer 21 may analyze the layout file to distinguish layout configuration information or layer from object information or layer included therein. Further, the layout configuration information or layer from object information or layer may be used to configure an image that may be displayed on a screen of at least one of the transmission device 10 and the reception device 20. For convenience of disclosure, the layout configuration information or layer may be referred to as, without limitation, a layout configuration, and the object information or layer may be referred to as, without limitation, an object.

The layout file may be implemented by the XML file and analyzed using a document object model (DOM) analyzer, which may be a type of an XML analyzer. In operation 2, the layout file analyzer 21 generates a DOM tree having a parent-child node relationship. More specifically, the layout file analyzer 21 may generate a DOM tree having a hierarchical relationship between the layout configuration and one or more objects included in the layout file. Further, the layout file analyzer 21 may distinguish between the layout configuration and the object as the DOM tree is generated.

In operation 3, the layout file analyzer 21 transmits the layout file information, including the layout configuration and the object, to the information manager 22. The layout file information may be configured and stored in a management table in the information manager 22.

In operation 4, the information manager 22 may extract the resource ID included in the layout configuration and the object and sends the resource ID to the resource processor 23 to request resources, which may be applied to the layout configuration and one or more objects included in the layout file. In an example, resources may include, without limitation, at least one of an image, audio, video, a text string, a layout, an XML file, and the like.

Referring to operation 5 of FIG. 7, the resource processor 23 transmits the resource ID to the transmission device 10 to request the resources. In operation 6 of FIG. 7, the resource processor 23 receives the resources from the transmission device 10. Further, the resource processor 23 may receive the resources from the transmission device 10 if the resources are present in the transmission device 10. In operation 5 of FIG. 8, the resource processor 23 transmits the resource ID to the cloud server 30 to request the resources. In operation 6, of FIG. 8 the resource processor 23 receives the resources. Further, the resource processor 23 may receive the resources from the cloud server 30 if the resources are present in the cloud server 30.

If the resources are present in the cloud server 30, Uniform Resource Locator (URL) information used to access the cloud server 30 may be included in the XML file.

In operation 7, the resource processor 23, which receives the resources from the transmission device 10 or the cloud server 30, stores the received resources in the information manager 22.

In operation 8, the output unit 24 may apply the resources obtained through the resource processor 23 to the layout configuration and one or more objects of the layout file analyzed by the layout file analyzer 21 to configure a user interface and output the user interface on the screen.

In operation 9, when a user input is detected on the input unit 25, the input unit 25 sends the position and type of the user input to the input determination unit 26.

In operation 10, the input determination unit 26, which receives the position and type of the user input from the input unit 25, extracts, without limitation, at least one of the ID of the object information associated with the event occurrence, the type of the event, the layout ID, the application ID, and the transmission device information from the information manager 22. In operation 11, the information manager 22 directs the received information to the event processor 27 to request event processing.

In operation 13, the event processor 27 establishes communication with the transmission device 10 using the transmission device information received from the input determination unit 26. Further, the event processor 27 may transmit, without limitation, at least one of the object ID, the event type, the layout ID and the application ID to the transmission device 10 to request event processing.

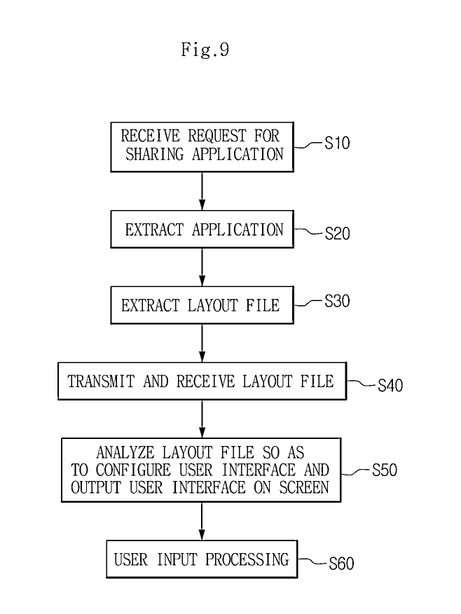

FIG. 9 is a flowchart illustrating a data sharing method according to an exemplary embodiment of the present invention. The method of FIG. 9 below will be described as if performed by the transmission terminal 10 of FIG. 5 and the reception terminal 20 of FIG. 6, but are not limited as such.

In operation S10, the transmission device 10 transmits a request for sharing an application, which is received by the reception device 20. In operation S20, application or data to be shared is extracted from the transmission device 10. In operation S30, a layout file of the application is extracted. Further, the reception device 20 may extract at least one of a resource ID of an execution screen of the application, which may be an image that may be displayed on a screen of the transmission device 10 in association execution of the application, and a layout file name corresponding to the resource ID. In operation S40, the reception device 20 receives the extracted layout file from the transmission terminal 10. In operation S50, the layout file transmitted by the transmission device 10 is analyzed to configure a user interface and output the user interface on a screen. More specifically, the layout file may be analyzed to distinguish the layout configuration from one or more objects that may be included in the layout file, which may be used to configure the user interface. In operation S60, a user input detected through the user interface is processed.

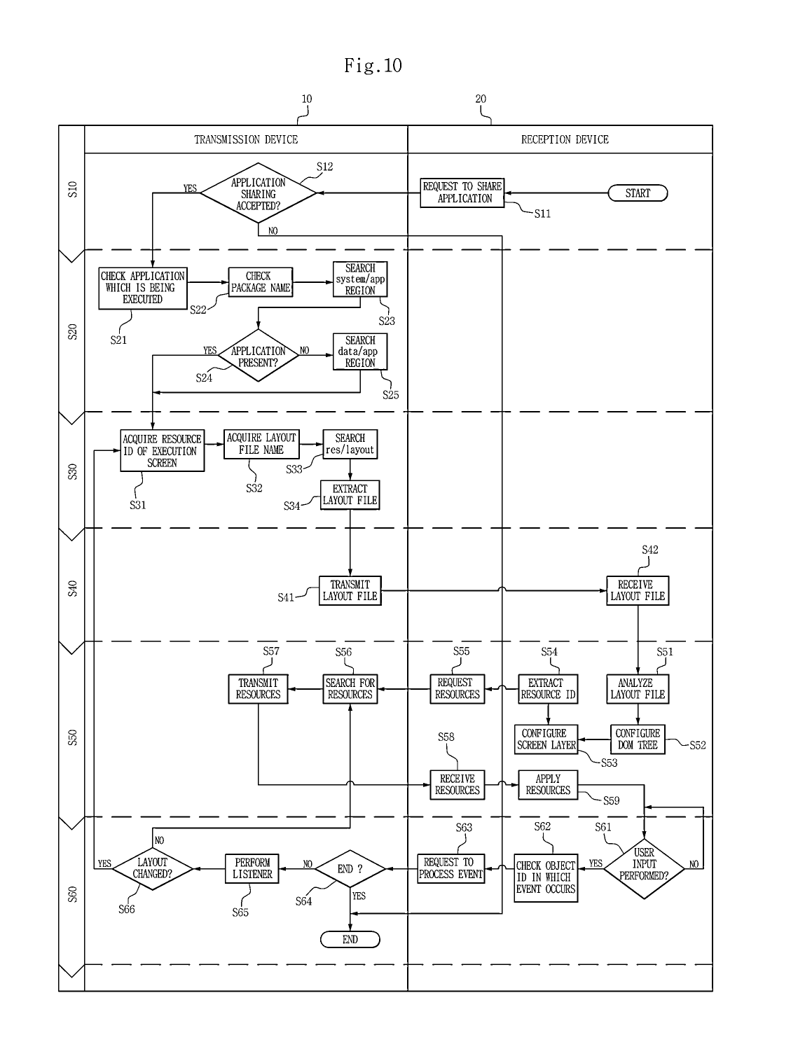

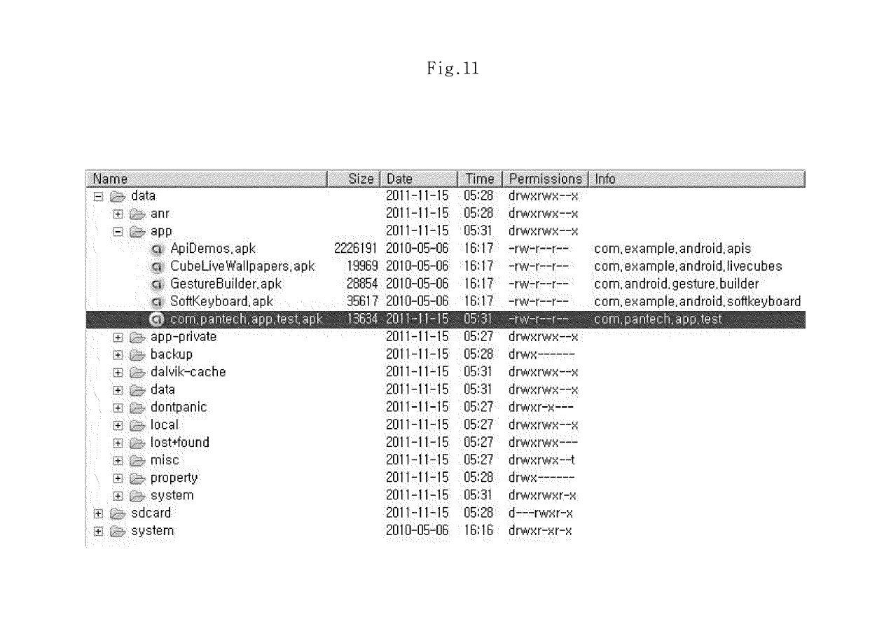

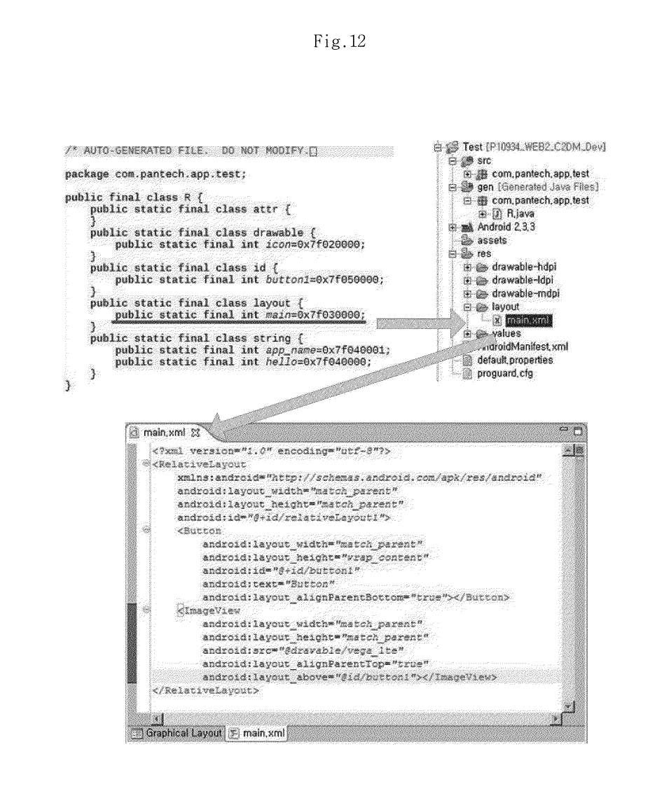

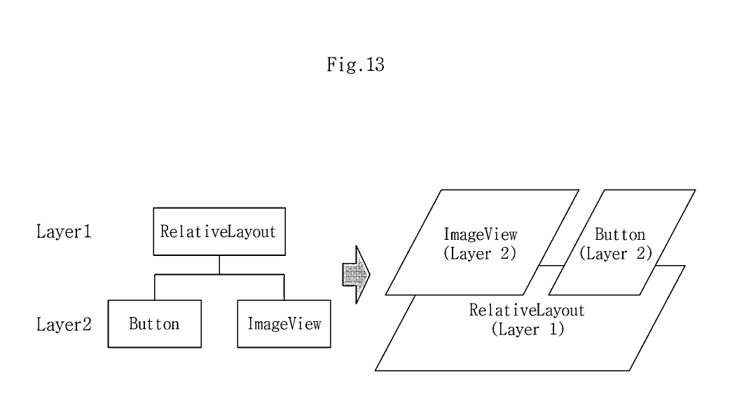

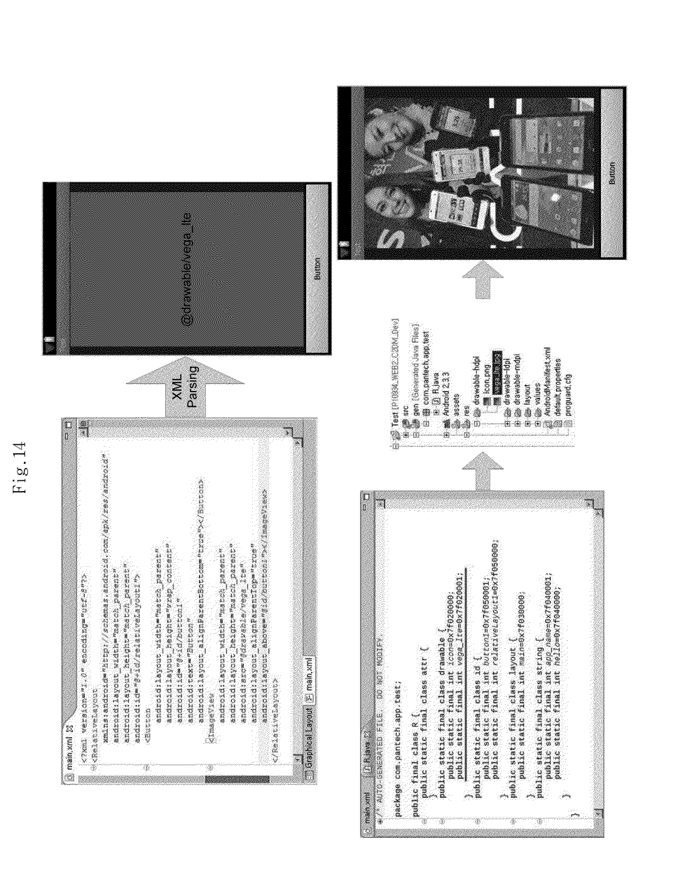

Hereinafter, aspects of the invention will be described in greater detail with reference to FIG. 10. FIG. 10 is a flowchart illustrating a data sharing method according to an exemplary embodiment of the present invention. The method of FIG. 10 below will be described as if performed by the transmission terminal 10 of FIG. 5 and the reception terminal 20 of FIG. 6, but are not limited as such.

Although the exemplary embodiments of the present invention may be applicable to data or application sharing among a plurality of devices operating in different OS environments, data sharing between two devices will be exemplarily described. In addition, an application operating in a foreground mode may be described as the application to be shared in the exemplary embodiments. However, aspects of the invention are not limited thereto, such that an application that is not currently executed, such as an application operating in a background mode or stored in a memory, may be shared.

In operation S11, the reception device 20 transmits a request to share an application to the transmission device 10. Here, the reception device 20 may request the transmission device 10 to share one or more applications installed or stored in the transmission device 10. However, aspects of the invention are not limited thereto, such that data, an image file, a multimedia file, and the like may be requested to be shared.

Although FIG. 10 illustrates the reception devices 20 requesting the transmission device 10 to share its application, the transmission device 10 may request the reception device 20 to share its application as well. Similarly, one or more operations performed by the reception device 20 may be performed by the transmission device 10 and vice-versa.

In operation S12, the transmission device 10, which receives the request for sharing the application from the reception device 20, notifies a user of the transmission device 10 of the request to share its application, and receives a response, either an acceptance or a rejection, to share or not share the respective application. If the user refuses to share the application of the transmission device, the data sharing procedure is terminated. If the user accepts the request to share the application of the transmission device 10, the application of the transmission device is extracted in operation S20.

Moreover, a feature may be provided such that the transmission device 10 may be configured to automatically accept or deny a request for sharing data or an application. For instance, the transmission device 10 may be configured to automatically accept or deny a request for sharing data or an application based on, without limitation, at least one of an identity of the reception device, an identity of the application or data requested, a burden imposed on the transmission device software and physical resources (e.g. memory availability, processing load, and the like), number of applications requesting the application at the same time and the like.

In operation S21, the application extractor 11 of the transmission device 10 checks to determine whether the application to be shared is currently operating in a foreground mode.

If an Android® system is used, a package manager may be used to determine whether the application to be shared is currently operating in the foreground mode.

In operation S22, the transmission device 10 checks to determine a package name (e.g. com.pantech.app.test) of the application, which may be a unique identification value of the application determined in operation S21.

Similar to the operation of determining whether the application is operating in the foreground mode, a package manager may be used to determine the package name.

Since the package name may be a unique identification value of the application in the device, another application having the same package name may not present. Accordingly, it may be possible to distinguish the application using the package name, which may be used to search for a target application.

In operation S24, a system/app region of an internal memory, such as a flash memory, is searched using the determined package name and a determination of whether an application corresponding to the package name is present in the system/app region is made.

If the application having the package name is determined to be present in the system/app region in operation S24, operation S30 may be performed to extract the layout file of the application.

If the application having the package name is determined not to be present in the system/app region in S24, an application having the package name is searched for in the data/app region in operation S25. In operation S30, the layout file of the application is extracted.

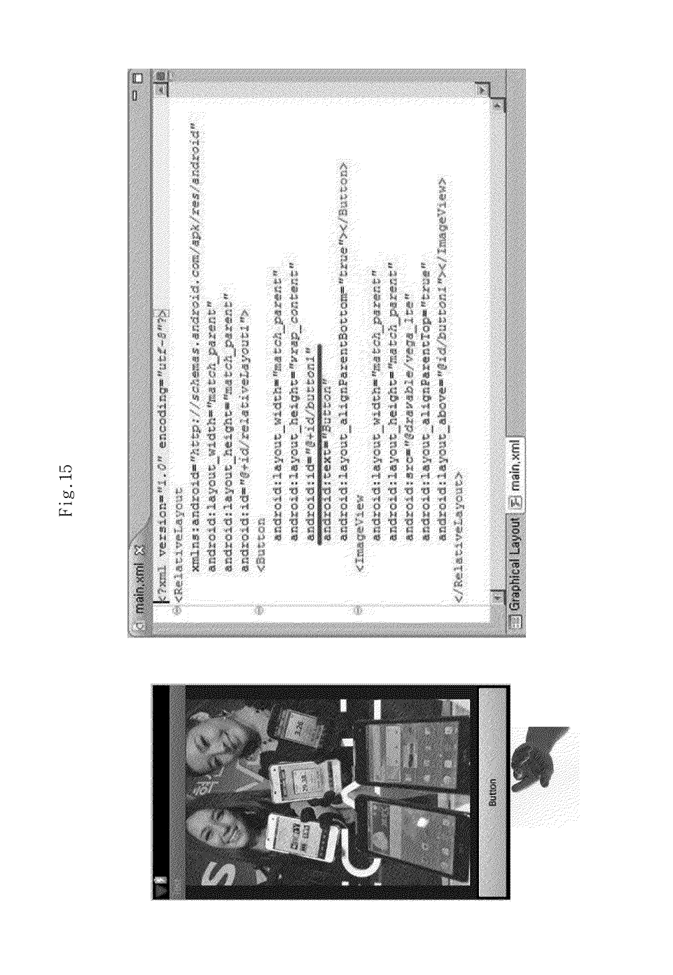

FIG. 11, FIG. 12, FIG. 13, FIG. 14 and FIG. 15 are diagrams illustrating an operation of a data sharing system according to exemplary embodiments of the present invention.

FIG. 11 shows an exemplary embodiment in which the package name (e.g., com.pantech.app.test) of the application is present in the data/app region of the internal memory.

In operation S31, if the operation S20 of extracting the application is finished, the layout file extractor 12 of the transmission device 10 acquires a resource ID of a screen of the application that is currently executed, or an image displayed during an execution of the application. The screen of the application currently executed or the image displayed during an execution of the application may be referred to as, without limitation, an execution screen.

If the resource ID of the execution screen of the application is acquired in operation S31, in operation S32, a layout file name of the resource ID is acquired from layout file names of the resource IDs declared in R.java, which may automatically be generated to manage a memory for text resources defined in a string. xml file for managing resources, image resources in a res/drawable folder and an xml file in a res/layout folder.

In operation S33, a layout file, which may be stored in the res/layout folder in the application extracted in operation S20, is searched using the acquired layout file name. In operation S34, a layout file corresponding to the layout file name is extracted.

For example, as shown in FIG. 12, when the resource ID of the execution screen is of the application, which may be operating in the foreground mode, is 0x7F030000, the layout file name of the resource ID is “main”. Accordingly, if a res/layout path of the application (e.g., com.pantech.app.test) is searched for using the layout file name “main”, a layout file (main.xml file) matching the layout name “main” is extracted.

The layout file extracted in operation S34 may be implemented by an XML file as described above.

In operation S41, the transmission device 10 transmits the layout file. In operation S42, the reception device 20 receives the extracted layout file of transmission device 10.

In operation S41 and operation S42, the transmission device 10 and the reception device 20 may transmit and/or receive the layout file using various network protocols, such as HTTP, WiFi, Direct, and the like.

In operation S51, the layout file analyzer 21 of the reception device 20, which receives the layout file from the transmission device 10 in operation S41, analyzes the layout file implemented by the XML file using a DOM analyzer, which may be a type of an XML analyzer. More specifically, the layout file analyzer 21 may identify and distinguish the layout configuration from one or more objects included in the layout file. In operation S52, the layout file analyzer 21 represents or configures components of the layout file, which may be distinguished and obtained by analysis, in the form of a DOM tree.

The components of the layout file represented in the form of the DOM tree in operation S52 may refer to a layout configuring a screen or image displayed on a device, which may include one or more objects. More specifically, the one or more objects may be superimposed over a base screen or screen layout to provide the displayed image. Further, the depth of the DOM tree may indicate the number of layers or hierarchy of the screen layout.

In operation S53, the layout configuration and the object are divided into layers according to depth to configure a screen layer.

For example, as shown in FIG. 13, the DOM tree configuration corresponding to a layout file (e.g., main.xml file) includes one RelativeLayout layer, which may be a layout for specifying a relationship between a parent layer, such as a base layer or a background layer, and a child layer, such as a widget or control mechanisms, and a positional relationship between widgets to place a view. Further, the DOM tree configuration also includes one Button layer, and one ImageView layer. The RelativeLayout layer may be located at Layer 1 or Depth 1 and the Button layer and the ImageView layer is located at Layer 2 or Depth 2, which is located at a lower level of RelativeLayout layer in the DOM tree configuration.

In the screen layout configured according to the DOM tree configuration, the RelativeLayout layer is disposed at a lowest level, and the ImageView layer and the Button layer are both disposed at a higher level than the RelativeLlayout layer. The Button layer and the ImageView layer are disposed on the same level. More specifically, the RelativeLayout layer may be overlapped by the Button layer and the ImageView layer, such that user may see the Button layer (e.g., control buttons) and the ImageView layer (e.g., a picture) superimposed over the RelativeLayout layer (e.g., background screen).

When the screen layer is configured in operation S53, the sizes of the layout configuration providing a background or base screen and one or more objects included in the layout file, which may be superimposed over the layout configuration, are applied. At this time, various attributes, such as “match_parent” and “wrap_contnet,” may be used.

In operation S54, in order to apply resources to the screen layout configuration and one or more objects included in the layout file, the resource ID included in the layout configuration and the objects is extracted from the layout file.

The extraction of the resource ID in operation S54 may correspond to a process of extracting attributes used to represent actual data of the object, such as src, background, and/or text.

In operation S55, the extracted resource ID is transmitted to the transmission device 10 to request resources.

In operation S55, if the resources are determined to be present in the cloud server 30, the resource ID is transmitted to the cloud server 30 to request resources.

In operation S56, the resource processor 15 of the transmission device 10, which receives the resource request from the reception device 20 in operation S55, searches to identify one or more resources using the resource ID received from the reception device 20. In operation S57, the transmission device 10 transmits the searched resources to the reception device 20. In operation S58, the reception device 20 receives the searched resources from the transmission device 10.

In operation S59, the output unit 24 of the reception device 20, which receives resources from the transmission device 10 in operation S58, applies the resources acquired in operation S54, operation S55, operation S56, operation S57, and operation S58 to the layout configurations and the objects to configure a user interface, and output the user interface on the screen.

For example, as shown in FIG. 13, the reception device 20, which may receive the main.xml file from the transmission device 10, analyzes the received main.xml file, configures a layout of the screen layer to have the Button object layer and the ImageView object layer to be is disposed over the RelativeLayout layer in the layout. Further, the reception device 20 may extract the resource ID included in the layout configuration and one or more objects included in the layout file, such as the RelativeLayout layer, Button object layer, and the ImageView object layer, to apply the resources to the layout configuration and the objects.

As shown in FIG. 14, if “@drawable/vega_lte”, which may be a source src, is extracted as a resource to be included in the ImageView object, then as a result of extracting the resource ID, “@drawable/vega_lte” may be transmitted to the transmission device 10 to request resources. The transmission device 10, which may receive the resource request, transmits an image corresponding to “@drawable/vega_lte” to the reception device 20. The reception device 20, which may receive the image, may apply the received image to the ImageView object to output the image on the screen.

In operation S61, a determination of whether a user input is detected using the user interface is made. In operation S62, if the user input is detected using the user interface, which may be output on the screen of the reception device 20, event information may be extracted. The event information may include at least one of the ID of an object for which an event occurrence is detected, the type of the event, a layout ID, an application ID, and transmission device information, which may be extracted based on the position and type of the user input. In operation 63, at least one of the object ID, the event type, the layout ID and the application ID may be transmitted to the transmission device 10 using the transmission device information to request event processing.

In operation S64, the transmission device 10, which receives the event processing request from the reception device 20 in operation S63, checks to determine whether the event is an end event based on the event information included in the event processing request, which may include at least one of the object ID, the event type, the layout ID, and the application ID. In operation S65, the transmission device 10 finishes the event if the event is determined to be an end event, and performs a listener operation if the event is not an end event.

In operation S66, a determination of whether layout is changed is made. More specifically, a determination of whether the layout is change in response to performing the listener may be made. If the transmission device 10 determines that the resources of the object are changed by performing the listener operation but the layout is not changed, the method proceeds to operation 56 to search to identify one or more resources using the resource ID, and to transmit resources in operation S57. In operation S58, the reception device 20 receives the resources from the transmission device 10.

In operation S59, the reception device 20, which receives the resources from the transmission device 10 in operation S58, applies the received resources to the object to output the object on the screen and thus the changed object may be updated without changing the layout.

If the layout is determined to have changed by performing the listener in operation S66, the method proceeds to perform operation S31 to acquire the resource ID of the screen to be changed and the subsequent steps thereof are repeatedly performed to transmit the layout file to the reception device 20. The reception device 20 analyzes the layout file received from the transmission device 10 and outputs the changed layout on the screen.

For example, as shown in FIG. 15, if user input of pressing a button is performed through the user interface, object ID “@id/button1”, which may be an object ID of the button, may be extracted from the layout file and transmitted to the transmission device 10 to request event processing. Further, the transmission device 10 may perform a listener defined in the object ID “@id/button1” according to the event processing request. If only the resources of the ImageView object are changed with a different image by performing the listener operation, the different image may be searched for and transmitted to the reception device 20. The reception device 20 may apply the different image, which may be the resource received from the transmission device 10, to the ImageView object to update only the resource with the different image.

As described above, sharing of the application operating in the foreground mode according to exemplary embodiments of the present invention has been described.

Further, if an application that may not operating in the foreground mode is shared, the transmission device 10 may extract the application to be shared and acquire a resource ID of an execution screen provided according to execution of the extracted application (e.g., a main screen). Here, the application to be shared may operate in a background mode.

As described above, the transmission device 10, which may acquire the layout file name matching the resource ID of the main screen, may extract a layout file using the acquired layout filename and may transmit the layout file to the reception device 20. The subsequent steps thereof may be similar or the same as the steps of sharing the application operating in the foreground mode and thus a description thereof will be omitted.

As described above, according to an exemplary embodiment of the present disclosure, if a user interface is shared by sharing a layout file, then at least one of data, such as text, images, audio and video may be shared between devices operating in different OS environments.

Further, according to exemplary embodiments of the present disclosure, if a transmission device operating in an Android® environment shares specific data operating in the Android® environment with a reception device operating in an iOS® environment, the transmission device may share the data with the reception device by sharing a user interface of an application used to process the data to be shared with the reception device.

Moreover, if data is shared between devices operating in different OS environments by sharing a layout file to share a user interface of an application according to exemplary embodiments of the present invention, a likelihood of an image becoming blurred or distorted even when the devices are different in terms of resolution may be reduced.

Thus, according to exemplary embodiments of the present invention, since the layout information is shared between the devices, which may be different in terms of resolution, and the resources included in the layout are represented as being defined in the layout, a likelihood of an image becoming blurred or distorted may be reduced.

Further, exemplary embodiments of the present invention may be applicable to remote control between devices. More specifically, it may be possible to remotely control other device by sharing a layout file composed of text.

Further, according to exemplary embodiments of the present invention, by sharing a layout file configuring a user interface of an application to share the user interface of the application, an application may be shared between devices operating in different OS environments.

Accordingly, an application operating in a specific OS environment (e.g., an iOS® environment) may be shared with a device operating in another OS environment (e.g., a Windows® environment).

For example, a mobile instant messenger program (e.g., Kakao Talk®) installed in a smart phone may be used in a PC operating in a Windows® environment.

Here, screen output and user input may be performed in the PC while the other operations may be performed in the smart phone.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for sharing data between a first device and a second device, the method comprising:
transmitting, by the first device, a request for sharing data to the second device;
receiving, at the first device, a layout file corresponding to the shared data of the second device;
extracting, at the first device, at least one of a layout configuration and an object included in the layout file;
receiving, at the first device, resources corresponding to at least one of the layout configuration and the object from an external source;
applying, at the first device, the received resources to at least one of the layout configuration and the object; and
configuring, at the first device, a user interface using the applied layout configuration and the object.

2. The method of claim 1, further comprising;
extracting resource identification (ID) corresponding to at least one of the layout configuration and the object from the layout file,
wherein the resource identification ID is used to identify the resources to be received.

3. The method of claim 1, wherein the external source is the second device.

4. The method of claim 1, wherein the external source is a cloud server.

5. The method of claim 1, further comprising:
detecting, at the first device, an input on the user interface for executing an event;
determining, at the first device, a position and type of the detected input;
extracting, at the first device, event information based on the detected input; and
transmitting, to the second device, the event information for event processing.

6. The method of claim 5, further comprising:
determining, at the second device, whether the event is an end event based on the event information,
wherein if the event is determined not to be an end event, performing, at the second device, a listener operation, and determining whether a layout of the user interface is changed in response to the listener operation.

7. The method of claim 6, wherein if a resource corresponding to the object in the user interface is changed, acquiring, at the second device, a corresponding resource ID of an execution screen displayed on the second device.

8. The method of claim 6, wherein if the layout of the user interface is unchanged, searching to identify another resource corresponding to a resource ID received from the first device.

9. The method of claim 1, wherein the layout file is analyzed for identifying the layer configuration and the object, and determining a layer hierarchy for the layer configuration and the object using a document object model (DOM) analyzer.

10. The method of claim 1, wherein the layout configuration and the object are configured according to a layer hierarchy.

11. The method of claim 1, wherein the data to be shared comprises an application.

12. A data sharing system comprising a first device and a second device, the first device comprising:
a layout file analyzer to receive a layout file and to extract a layout configuration and an object included in the layout file, the layout file corresponding to shared data of the second device;
a resource processor to receive resources corresponding to at least one of the layout configuration and the object from an external source; and
an output unit to apply the resources to at least one of the layout configuration and the object and to configure a user interface using the applied layout configuration and the object.

13. The data sharing system of claim 12, wherein the layout file analyzer extracts resource identification (ID) corresponding to at least one of the layout configuration and the object, in which the resource identification ID is used to identify the resource to be received.

14. The data sharing system of claim 12, further comprising:
an input determination unit to detect an input on the user interface to execute an event, and to determine a position and type of the detected input;
an information manager to extract event information based on the detected input; and
an event processor to transmit the event information to the second device to process the event.

15. The data sharing system of claim 14, wherein the second device determines whether the event is an end event based on the event information, to perform a listener operation if the event is determined not to be an end event, and to determine whether a layout of the user interface is changed in response to the listener operation.

16. The data sharing system of claim 15, wherein if a resource corresponding to the object in the user interface is changed, the second device acquires a corresponding resource ID of an execution screen displayed on the second device.

17. The data sharing system of claim 15, wherein if the layout of the user interface is unchanged, the second device searches to identify another resource corresponding to a resource ID received from the first device.

18. The data sharing system of claim 11, wherein the output unit configures the layout configuration and the object according to a layer hierarchy.

19. The data sharing system of claim 11, wherein the layout file analyzer identifies the layer configuration and the object, and determines a layer hierarchy of the layer configuration and the object using a document object model (DOM) analyzer.

20. A method for sharing an application between a first device and a second device, the method comprising:
transmitting, by the first device, a request for sharing the application to the second device;
receiving, at the first device, a layout file of the application being executed in the second device;
extracting, at the first device, a layout configuration, an object, and corresponding resource identification (ID) included in the layout file;
receiving, at the first device, resources corresponding to the layout configuration and the object from an external source using the resource ID;
applying, at the first device, the received resources to the layout configuration and the object; and
configuring a user interface using the applied layout configuration and the object.
